(19) United States
(12) Patent Application Publication
(10) Pub. No.: US 2026/0170178 A1
(43) Pub. Date: Jun. 18, 2026

(54) TARGETED QUERY MUTATION TO DISCLOSE PROTECTED ROWS IN A DATABASE

(71) Applicant: Oracle International Corporation, Redwood Shores, CA (US)

(72) Inventors: Balasuriyage Anjana Visula PERERA, Enrina Heights (AU); François GAUTHIER, Indooroopilly (AU); Kostyantyn VOROBYOV, Brisbane (AU); Padmanabhan KRISHNAN, Varsity Lakes (AU)

(73) Assignee: Oracle International Corporation, Redwood Shores, CA (US)

(21) Appl. No.: 18/986,677

(22) Filed: Dec. 18, 2024

(51) Int. Cl. G06F 21/62; G06F 16/2452

(52) U.S. Cl. CPC G06F 21/6281; G06F 16/24526

(57) ABSTRACT

A method implements targeted query mutation to disclose protected rows in a database. The method involves selecting a predicate from a benign query. The benign query is to a database that includes a protected row. The benign query does not access the protected row. The method further involves identifying a row satisfaction objective for the predicate using the context of the predicate within the benign query and using a mutation condition. The method further involves mutating the predicate to generate a mutated predicate. Mutating the predicate is targeted by modifying the predicate to satisfy the mutation condition and the row satisfaction objective. The method further involves mutating the benign query to generate a mutated query that includes the mutated predicate to access the protected row. The mutated query is used by an injection prevention application to reject a subsequent query.

### BACKGROUND

An injection prevention application may implement an application-level runtime structured query language injection (SQLi) prevention approach (RSIPA) that records benign queries issued by a database application in a trusted environment. The injection prevention application uses benign queries as a proxy for the intent of what information of the database should be disclosed by the application. The benign queries are then transformed to an internal representation (IR), e.g., n-tuples, that captures the information disclosure of the benign queries, which is consolidated into a policy. A new incoming query may be permitted if the incoming query discloses less information than the benign queries, which is determined using the internal representation of the incoming query and the policy created with benign queries.

The injection prevention application may prevent unwarranted information disclosure from a database, i.e., prevent exfiltration. Unwarranted information disclosure may be the disclosure of information from the database (e.g., data stored in the database) that is not within the scope of the benign queries, i.e., within the disclosure intent, of the application accessing the database (the database application). As an example, an online store application should not disclose credit card numbers (i.e., protected information) of customers as a response to a query originated from an external user request. An unwarranted information disclosure occurs if a query from a user request retrieves at least one record from the database that is protected. Since the injection prevention application learns the disclosure intent of a database application through benign queries, the injection prevention application may provide protection against data exfiltration attacks attempting unwarranted information disclosure.

The injection prevention application may be tested for a given security criterion. The security criterion determines the level of unwarranted information disclosure injection prevention applications are tested for. Disclosing data from protected columns, i.e., columns in a table containing sensitive data, and disclosing data from protected rows, i.e., rows in a table containing sensitive data, are two examples of security criteria. The protected column criterion is about column-level security and the protected row criterion is about row-level security of databases, both of which are recognized in the database security space.

A data exfiltration attack query attempting unwarranted information disclosure from a database may bypass the injection prevention application. The bypass may happen for many reasons, including: i) the internal representation is not able to capture the complete information disclosure of a query, ii) issues in the construction of internal representation for a query, iii) issues in policy synthesis, i.e., how internal representations are consolidated, iv) over-generalization caused by row-based generalization, v) issues in policy enforcement, etc. Testing the injection prevention application against such data exfiltration attack queries may be used to strengthen the defenses of the injection prevention application by fixing issues in policy synthesis and enforcement. Challenges remain with generating queries that may be used to strengthen the defenses of the injection prevention application against exfiltration attack queries.

### SUMMARY

In general, in one or more aspects, the disclosure relates to a method that implements targeted query mutation to disclose protected rows in a database. The method involves selecting a predicate from a benign query. The benign query is to a database that includes a protected row. The benign query does not access the protected row. The method further involves identifying a row satisfaction objective for the predicate using the context of the predicate within the benign query and using a mutation condition. The method further involves mutating the predicate to generate a mutated predicate. Mutating the predicate is targeted by modifying the predicate to satisfy the mutation condition and the row satisfaction objective. The method further involves mutating the benign query to generate a mutated query that includes the mutated predicate to access the protected row. The mutated query is used by an injection prevention application to reject a subsequent query.

In general, in one or more aspects, the disclosure relates to a system that includes at least one processor and an application that executes on the at least one processor. Executing the application performs selecting a predicate from a benign query. The benign query is to a database that includes a protected row. The benign query does not access the protected row. Executing the application further performs identifying a row satisfaction objective for the predicate using the context of the predicate within the benign query and using a mutation condition. Executing the application further performs mutating the predicate to generate a mutated predicate. Mutating the predicate is targeted by modifying the predicate to satisfy the mutation condition and the row satisfaction objective. Executing the application further performs mutating the benign query to generate a mutated query that includes the mutated predicate to access the protected row. The mutated query is used by an injection prevention application to reject a subsequent query.

In general, in one or more aspects, the disclosure relates to a non-transitory computer readable medium including instructions executable by at least one processor. Executing the instructions performs selecting a predicate from a benign query. The benign query is to a database that includes a protected row. The benign query does not access the protected row. Executing the instructions further performs identifying a row satisfaction objective for the predicate using the context of the predicate within the benign query and using a mutation condition. Executing the instructions further performs mutating the predicate to generate a mutated predicate. Mutating the predicate is targeted by modifying the predicate to satisfy the mutation condition and the row satisfaction objective. Executing the instructions further performs mutating the benign query to generate a mutated query that includes the mutated predicate to access the protected row. The mutated query is used by an injection prevention application to reject a subsequent query.

Other aspects of one or more embodiments may be apparent from the following description and the appended claims.

### BRIEF DESCRIPTION OF DRAWINGS

FIG. 1 shows a diagram in accordance with the disclosure.

FIG. 2 shows a method in accordance with the disclosure.

FIG. 3, FIG. 4, FIG. 5, FIG. 6, FIG. 7, and FIG. 8 show examples in accordance with the disclosure.

FIG. 9A and FIG. 9B show computing systems in accordance with the disclosure.

Similar elements in the various figures may be denoted by similar names and reference numerals. The features and elements described in one figure may extend to similarly named features and elements in different figures.

### DETAILED DESCRIPTION

Implementations of the disclosure use targeted query mutation to disclose protected information in a database. The mutated queries may be used as negative samples to strengthen an injection prevention application. The targeted query mutation technique mutates predicates of benign queries to generate potential data exfiltration queries that may disclose protected data from a database. Even when the protected rows are unknown during generation of the mutated queries, the technique leverages the benign queries (also referred to as permitted non-exfiltrating queries) to approximate the protected rows in the database. Row satisfaction objectives for predicates of permitted non-exfiltrating queries are determined and used to generate predicate mutations aimed at satisfying the row satisfaction objectives. As an example, a benign query is received from which a mutated query is generated that may access protected data in a database. The predicates within the benign query are identified and row satisfaction objectives for each of the predicates is identified. From the predicates, predicate mutations are generated to satisfy mutation conditions that correspond to row satisfaction objectives. The mutated predicate may replace the predicate in the benign query to form the mutated query, which may then be used as a negative sample for an injection prevention application.

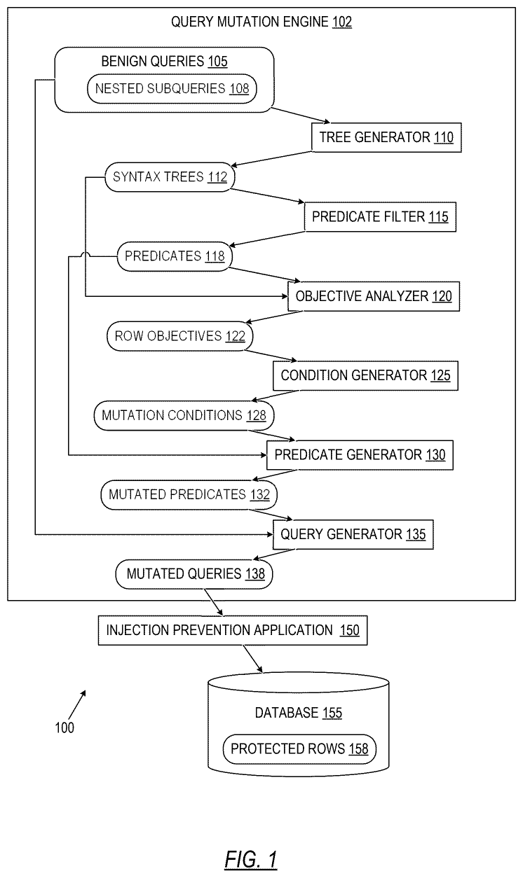

Turning to FIG. 1, the system (100) is a collection of hardware and software components that implement targeted query mutation to disclose protected rows in a database. The system (100) includes at least one processor and memory storing data and programs that execute on the processor(s). The system (100) uses the query mutation engine (102) to generate the mutated queries (138), which may be used to update the injection prevention application (150) to prevent exfiltration of data from the protected rows (158) from the database (155). Although shown as monolithic, the system (100) may be distributed with the hardware and software components operating on multiple computing systems.

The query mutation engine (102) is a component of the system (100) that processes the benign queries (105) to generate the mutated queries (138). The query mutation engine (102) may include several components to process the benign queries (105), including the tree generator (110), the predicate filter (115), the objective analyzer (120), the condition generator (125), the predicate generator (130), and the query generator (135).

The benign queries (105) (also referred to as permitted non-exfiltrating queries) are queries that are safe and non-malicious. The benign queries (105) may retrieve, insert, update, or delete data from the database (155) without causing any harm or unauthorized access. The benign queries (105) may be written in a query language (e.g., structured query language (SQL) using a syntax that may be recognized by the database (155)). The benign queries (105) may be received from applications that access the database (155). The benign queries (105) may be input to the tree generator (110). The benign queries (105) may include the nested subqueries (108).

The nested subqueries (108), which may also be referred to as inner queries, are queries embedded within another query, e.g., one of the benign queries (105), to handle complex data retrieval tasks by dividing the original query into simpler sub-tasks. The nested subqueries (108) may be executed first with the corresponding results being used by the outer query to perform operations such as filtering, aggregating, data manipulation, etc.

The tree generator (110) is a component of the query mutation engine (102). The tree generator (110) generates the syntax trees (112) from the benign queries (105). The tree generator (110) may parse and organize the elements of the benign queries (105), including the nested subqueries (108) and the predicates (118), into a tree structures that form the syntax trees (112).

The syntax trees (112) are hierarchical representations of the benign queries (105), generated by the tree generator (110). The syntax trees (112), which may be abstract syntax trees (ASTs), break down the queries into their fundamental components, such as clauses, predicates, and expressions, reflecting their logical structure and dependencies. Each node in a syntax tree may represent a specific element of the query, such as a SELECT clause, a WHERE clause, one of the nested subqueries (108), etc. The edges between nodes illustrate the relationships between these elements, forming a hierarchical tree-like structure. For example, a node representing a WHERE clause may have child nodes for each condition within the clause. One of the syntax trees (112) may correspond to one of the benign queries (105).

The predicate filter (115) is a component of the query mutation engine (102) that identifies the predicates (118) from the syntax trees (112). The predicate filter (115) analyzes the hierarchical structure of the syntax trees (112) to locate and extract the predicates (118).

The predicates (118) are expressions from within the benign queries (105) that specify criteria for filtering data. The predicates (118) represent logical statements that may determine which rows from the database (155) are to be included or excluded based on the specified expressions in response to the benign queries (105). One of the predicates (118) may correspond to one of the nodes of one of the syntax trees (112).

The objective analyzer (120) is a component of the query mutation engine (102) that generates row objectives (122) from the predicates (118) and the syntax trees (112). The objective analyzer (120) may identify the relationships between the predicates (118) and whether the predicates (118) are in the nested subqueries (108) to generate the row objectives (122).

The row objectives (122), also referred to as row satisfaction objectives (RSOs), are local objectives used to guide the mutation of predicates in queries. The row objectives (122) may be defined using set theory, focusing on the sets of rows that predicates in queries satisfy. The row objectives (122) are used to target specific predicate changes that are likely to result in accessing the protected rows (158) of the database (155). One of the row objectives (122) may correspond to one of the predicates (118).

The condition generator (125) is a component of the query mutation engine (102) that generates the mutation conditions (128) from the row objectives (122). The condition generator (125) analyzes the row objectives (122) to create specific mutation conditions that guide the mutation of predicates in the benign queries (105).

The mutation conditions (128) are criteria generated by the condition generator (125) based on the row objectives (122). The mutation conditions (128) define the changes to the predicates (118) in the benign queries (105) that may be used to transform the predicates (118) into the mutated queries (138). Different row objectives may have different mutation conditions. One of the mutation conditions (128) may correspond to one of the row objectives (122).

The predicate generator (130) is a component of the query mutation engine (102) that generates the mutated predicates (132) using the mutation conditions (128) and the predicates (118). The predicate generator (130) analyzes the mutation conditions (128) derived from the row objectives (122) and generates transformations to the predicates (118) from the benign queries (105) to form the mutated predicates (132).

The mutated predicates (132) are the result of transformations performed by the predicate generator (130) to the predicates (118). The mutated predicates (132) are altered from the predicates (118) from the benign queries (105) in accordance with the mutation conditions (128) to satisfy the row objectives (122). The mutated predicates (132) when incorporated into a query, may access one or more of the protected rows (158) in the database (155).

The query generator (135) is a component of the query mutation engine (102) that generates the mutated queries (138) using the mutated predicates (132) and the benign queries (105). The query generator (135) combines the modified predicates with the original structure of the benign queries (105) to create the mutated queries (138) that may access protected data from the protected rows (158) in the database (155). The query generator (135) may keep the logical and syntactical integrity of the benign queries (105) and minimize the changes to the benign queries (105) while incorporating the mutations from the mutated predicates (132).

The mutated queries (138) are outputs produced by the query generator (135). The mutated queries (138) are formed by integrating the mutated predicates (132) into the benign queries (105). The mutated queries (138) may simulate data exfiltration attempts on the database (155) to access data from the protected rows (158) and be used as negative samples for the injection prevention application (150).

The injection prevention application (150) is a set of hardware and software components that act as a security tool to protect the database (155) from unauthorized access and data exfiltration. The injection prevention application (150) analyzes queries to detect and block malicious attempts to exploit vulnerabilities in the database (155) and access the protected rows (158). The injection prevention application (150) uses the mutated queries (138) as negative samples to identify patterns and techniques used in injection attacks.

The database (155) is a structured collection of data stored and managed by the system (100). The database (155) organizes data in a way that allows efficient retrieval, insertion, updating, and deletion of information. The database (155) supports various types of queries, including those written in structured query language (SQL), to interact with the stored data. The database (155) may handle large volumes of data, data integrity, security, accessibility, etc., for authorized users and applications.

The protected rows (158) are specific entries within the database (155) that contain sensitive or confidential information. The protected rows (158) may be subject to access controls and security measures to prevent unauthorized access and data exfiltration. The protected rows (158) may be identified based on the nature of the data, which may include personal information, financial records, proprietary business data, etc.

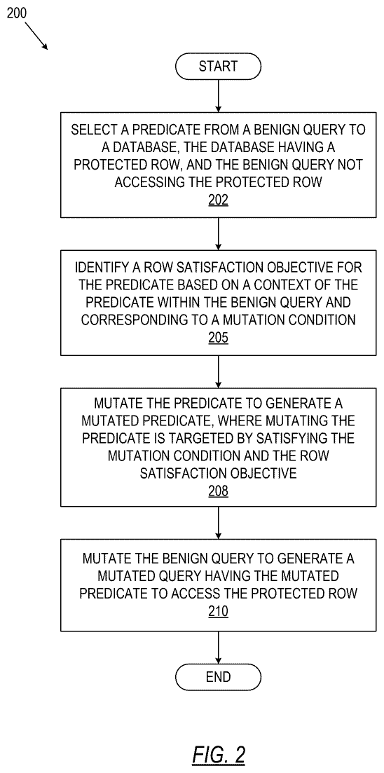

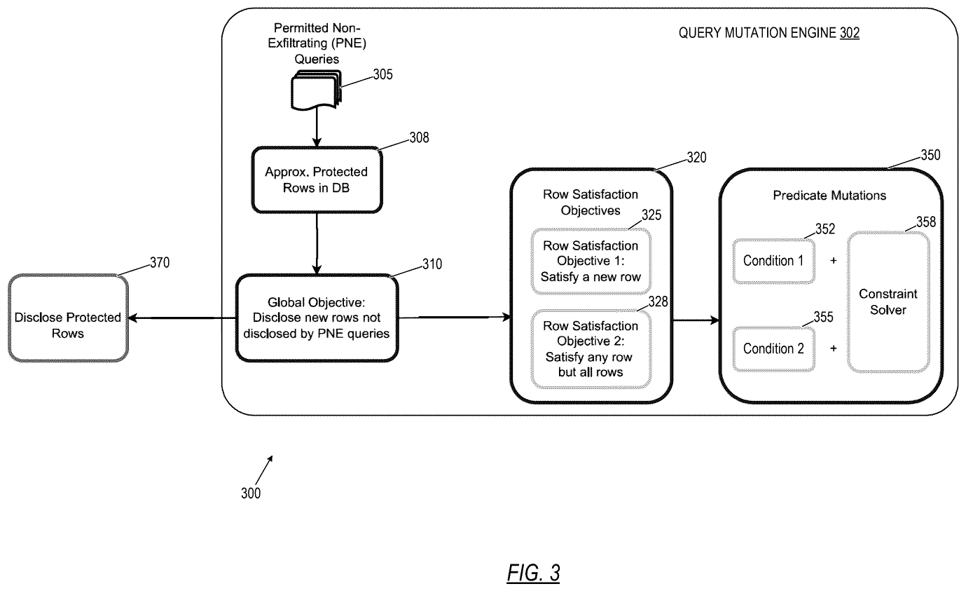

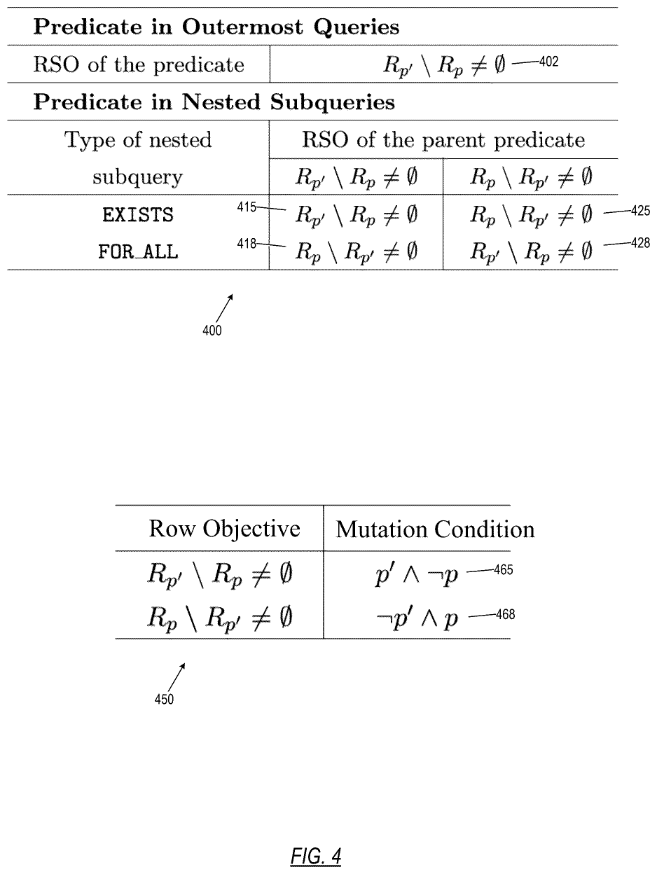

FIG. 2 shows a flowchart of a method implementing targeted query mutation to disclose protected rows in a database. The method of FIG. 2 may be implemented using the system of FIG. 1, and one or more of the steps may be performed on, or received at, one or more computer processors. The system may include at least one processor and an application that, when executing on the at least one processor, performs the method. A non-transitory computer readable medium may include instructions that, when executed by one or more processors, perform the method. The outputs from various components (including models, functions, procedures, programs, processors, etc.) for performing the method may be generated by applying a transformation to inputs using the components to create the outputs without using mental processes or human activities.

Turning to FIG. 2, the process (200) may perform targeted query mutation. The process (200) may include multiple steps (e.g., steps (202) through (210)) that may execute on the components described in the other figures, including those of FIG. 1.

Step (202) includes selecting a predicate from a benign query to a database including a protected row. The benign query does not access the protected row. The predicate may be selected by analyzing the structure of the query. The query may be parsed into a syntax tree, which hierarchically represents the components of the query, such as clauses, expressions, and nested subqueries. Within the syntax tree, predicates are identified as specific expressions that filter data based on certain criteria. The syntax tree may be scanned to locate the predicates. Each node in the syntax tree may be examined to determine if the node represents a predicate, such as those found in WHERE clauses or JOIN expressions of SQL statements. Once the predicates are identified within the syntax tree, one of the predicates may be selected. The order of selection of the predicates may be the order that the predicates are found in the syntax tree when being traversed.

Selecting the predicate may include parsing the benign query to generate a syntax tree representing the benign query. Parsing the benign query may include breaking down the query into multiple components, such as clauses, expressions, nested subqueries, etc. The parsing process may analyze the syntax of the benign query to identify the components. Each component is then organized into a hierarchical structure, forming the syntax tree. The syntax tree represents the logical relationships between the components of the benign query using nodes and edges. Nodes in the syntax tree may represent specific elements of the query, such as SELECT clauses, WHERE clauses, and individual predicates. Edges illustrate the relationships and dependencies between the nodes, creating a tree-like structure. For example, a SELECT clause node may have child nodes representing the columns to be selected and associated expressions, connected by edges.

Selecting the predicate may further include traversing a syntax tree of the benign query to identify the predicate. Traversing the syntax tree includes visiting each node in the hierarchical structure. The traversal process may follow different methods, such as depth-first search or breadth-first search, to explore the nodes. During traversal, each node representing a component of the benign query may be examined to determine if the node is a predicate. Nodes that represent predicates are identified based on their role in filtering data, such as expressions in WHERE clauses or JOIN expressions.

Step (205) includes identifying a row satisfaction objective for the predicate using a context of the predicate within the benign query and using a mutation condition. Identifying the row satisfaction objective includes analyzing the context in which the predicate appears within the benign query. The context may include the surrounding clauses, expressions, nested subqueries, etc. that influence the role of the predicate in filtering data. For example, the context may include whether the predicate is part of a nested subquery and, if so, identify the row objective for the parent of the nested subquery. The row satisfaction objective may determine a mutation condition used to identify the scope of potential mutated queries that may be generated from a benign query. The mutation condition guides the mutation process to form a modified predicate to target specific rows in the database, potentially accessing protected data.

Identifying the row satisfaction objective may further include determining the context using a syntax tree to identify a parent objective and a nested subquery type for the predicate. Determining the context includes analyzing the syntax tree to identify the hierarchical relationships between the predicate and other components of the benign query. The syntax tree is traversed to locate the parent predicate node of the node for the predicate. The parent predicate node may identify a row objective, referred to as a parent objective. Additionally, the syntax tree may be examined to identify the type of the nested subquery that include the predicate. As an example, the type of nested subquery may be EXISTS or FOR_ALL. Identifying the parent objective and the nested subquery type determines the context of the predicate to use to generate a mutated query.

Identifying the row satisfaction objective may further include resolving the row satisfaction objective using a parent objective and a nested subquery type. The row satisfaction objective may be resolved by referencing a table that maps various types of nested subqueries to corresponding row objectives of parent predicates. The table may include entries that specify how different nested subquery types, such as EXISTS or FOR_ALL, interact with the row objectives of parent predicates. By consulting the table, the appropriate row objective for the predicate may be determined based on the combination of the nested subquery type and the parent objective. Other methods that do not use a table may also be used.

Identifying the row satisfaction objective may further include annotating a syntax tree to include the row satisfaction objective with a predicate node representing the predicate within the syntax tree. The syntax tree may be traversed to locate the node that represents the predicate, i.e., the predicate node. Once the predicate node is identified, the row satisfaction objective may be determined based on the context of the predicate within the query. The row satisfaction objective may then be added as an annotation to the predicate node within the syntax tree.

Step (208) includes mutating the predicate to generate a mutated predicate. Mutating the predicate may be targeted by modifying the predicate to satisfy the mutation condition and the row satisfaction objective. The predicate may be analyzed to identify potential modifications that align with the specified mutation condition and row satisfaction objective. Various mutation techniques may be applied, such as altering comparison operators, changing constant values, or modifying logical connectors within the predicate. Each potential mutation may be evaluated to ensure that the resulting mutated predicate meets the criteria defined by the mutation condition and row satisfaction objective. The mutated predicate may then be generated by incorporating the selected modifications.

Mutating the predicate may include adjusting an element within the predicate using a temperature. The temperature may be a value that identifies the amount of change that may be made to the predicate to generate the mutated predicate. The temperature may identify a percentage change for the value of a constant, indicating how much the constant should be increased or decreased. For example, a temperature of 10% may suggest that a constant value of 100 could be adjusted to a value between 90 and 110. Additionally, the temperature may determine the number of different characters in the string that forms the query, guiding how many characters should be altered to create the mutated predicate.

Step (210) includes mutating the benign query to generate a mutated query comprising the mutated predicate to access the protected row. The benign query may be parsed to identify the location of the original predicate within the query structure. The mutated predicate may then be inserted into the benign query, replacing the original predicate while preserving the overall structure and logic of the query. Much of the syntax and semantics of the benign query may remain intact after the mutation. The mutated query may be constructed by integrating the mutated predicate into the benign query so that the mutated query may be executed by the database system. The execution and may access the protected row to simulate a potential data exfiltration attempt for testing and strengthening the injection prevention application. The mutated query may be used by an injection prevention application to reject a subsequent query.

The process (200) may further include receiving the benign query. The benign query may be received from an application or user interface that interacts with the database. The benign query may be transmitted over a network connection or retrieved from a stored procedure within the database system. Upon receipt, the benign query may be validated to ensure it conforms to the expected syntax and structure of the query language used by the database. The benign query may then be logged for auditing purposes and to maintain a record of the queries processed by the system.

The process (200) may further include returning the mutated query as a negative sample executed by an injection prevention application protecting the database. The mutated query may be transmitted to the injection prevention application via a secure communication channel. The injection prevention application may then execute the mutated query in a controlled environment to monitor and analyze behavior of the mutated query. The results of the execution may be logged and evaluated to identify any potential vulnerabilities or weaknesses in the security mechanisms of the database. Executing the mutated query, serving as a negative sample, may trigger the injection prevention application to refine the detection algorithms that are used and improve the ability to prevent data exfiltration attempts to protect the database against unauthorized access and malicious activities.

The process (200) may further include executing an injection prevention application to reject a subsequent query using the mutated query as a negative sample. The injection prevention application may analyze the mutated query to identify patterns and characteristics indicative of malicious intent. The patterns may be incorporated into the detection algorithms of the injection prevention application. When a subsequent query is received, the injection prevention application may compare the query against the learned patterns from the mutated query. If the subsequent query exhibits similar characteristics to the negative sample, the injection prevention application may flag the query as potentially malicious. The flagged query may then be rejected, preventing the subsequent query from being executed on the database. Rejecting the subsequent query in this manner increases the security of the database by proactively identifying and blocking queries that pose a risk of data exfiltration that may access protected rows.

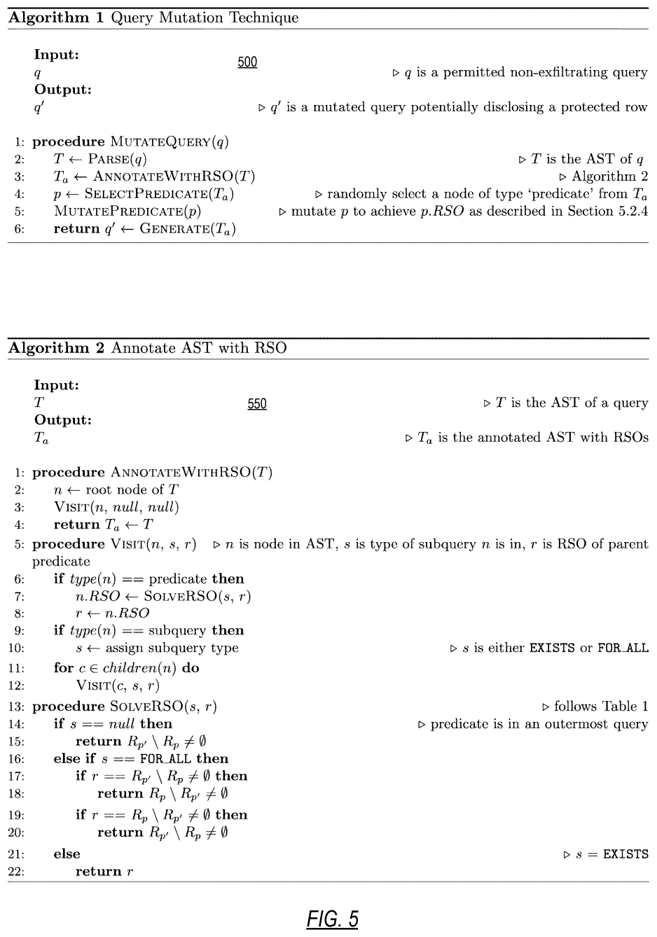

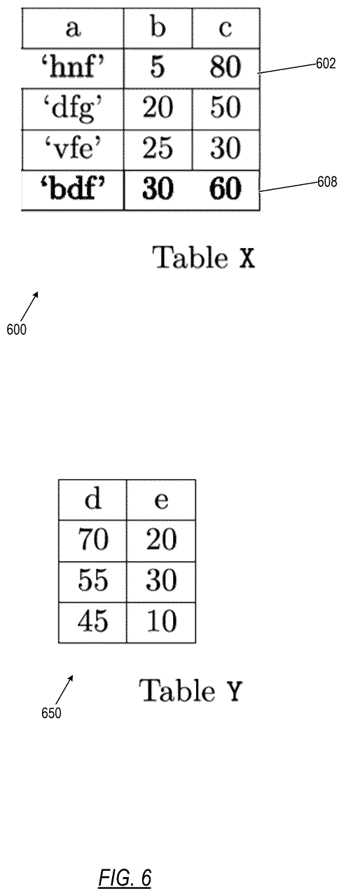

FIG. 3 through FIG. 8 show examples from implementations of the disclosure. The different examples may execute on the systems of the other figures.

Turning to FIG. 3, the system (300) includes the query mutation engine (302) to process the permitted non-exfiltrating queries (305) (which may also be referred to as benign queries) and generate mutated queries. The system (300) further includes the component (370). The component (308) approximates the rows in the database that may be protected. The component (310) defines a global objective that is used to generate the row objectives with the component (320) and by the component (370) to attempt to access protected rows using the mutated queries. The component (320) generates row objectives for predicates from the permitted non-exfiltrating queries (305) using the components (325) and (328). The component (325) may generate a first type of row objective. The component (328) may generate a second type of row objective. The component (350) generates predicate mutations based on the row objectives from the component (320) using the components (352), (355), and (358). The component (352) may be a first condition, referred to as a first mutation condition, used by the component (358) to generate a mutated predicate. The component (355) may be a second condition, i.e., a second mutation condition, used by the component (358) to generate a mutated predicate. The component (358) generates mutated predicates based on the mutation conditions of the components (352) and (355). The mutated predicates are used to generate mutated queries that the component (370) may execute to disclose protected rows in a database.

The component (308) may approximate the protected rows of a database by using the rows identified in the permitted non-exfiltrating queries (305) as a proxy. The protected rows in the database are unknown during test generation. The permitted non-exfiltrating queries (305) do not disclose protected rows. However, the rows accessed by the permitted non-exfiltrating queries (305) may be similar to rows that are protected. Hence, the protected rows are a subset of the rows that are not disclosed by the permitted non-exfiltrating queries (305), which may be probed by generating mutated queries that are similar to the permitted non-exfiltrating queries (305).

The component (310) may define global objectives. A global objective may be formulated for the query mutation technique as follows. If D_{q′}, and D_{q} are sets of rows that are returned by queries q and q′ where q is a permitted non-exfiltrating query and q′ is the query after mutation, respectively, then all q′ where D_{q′}/D_{q}≠∅ form a reduced search space of queries that also contains the queries disclosing the protected rows in the database. Specifically, D_{q′}/D_{q} has a row that is not disclosed by q. Not all rows in set D_{q′}/D_{q} may be protected.

The global objective of the mutation technique is to generate a query q′ from q by mutating the predicates of q such that D_{q′}/D_{q}≠∅, in other words, q′ discloses new rows that are not accessed or identified by q. The test generator does not know the exact data values stored in the database and cannot guarantee if a mutation will indeed result in disclosing a new row. For example, mutating the predicate x>4 to x>3 will disclose new rows, only if the respective table has a row with x=4. The query mutation technique utilized by the query mutation engine (302) is independent of any given state of the database.

The component (320) generates row satisfaction objectives. Since the query mutation technique mutates predicates in queries, the global objective, D_{q′}\D_{q}≠∅, is transformed to local objectives that work at the predicate level, such that achieving the local objectives is likely to result in achieving the global objective. The local objectives are referred to as row objectives (also referred to as row satisfaction objectives (RSOs)) for the predicate mutations. Set theory may be used to define the row objectives to focus on the rows satisfied by predicates in queries.

The predicates may be categorized based on the syntax of a query; i) predicates in outermost queries and ii) predicates in nested subqueries. For the predicates in outermost queries, the row objective is satisfying a new row. If such a predicate satisfies a row, then that row is likely to be disclosed by the query.

For the predicates in nested subqueries, the row objective may not be as straightforward as the predicates of the outermost queries. Predicates in nested subqueries have another predicate as a parent, which can be another predicate in a nested subquery or a predicate in the outermost query. For the predicates of nested subqueries, the row objectives are formulated to achieve the row objective of the parent predicate. The effect of a row objective of a nested subquery predicate propagates up to the outermost query and then to the global objective. At the same time, the query mutation technique may find the row objective of nested subquery predicates in a query when the row objective of the parent predicate is identified.

Additionally, the row objective of a nested subquery predicate may be based on the type of nested subquery the predicate is in. The nested subqueries can be categorized into two types: i) EXISTS and ii) FOR_ALL. Different row objectives may be formulated for predicates in different types of nested subqueries, which is further described with FIG. 4.

Row objective formulation may be different for different predicates. For predicates in outermost queries, let q. be an outermost query with predicates p₁, . . . , pₙ in its conditional clauses such as WHERE, HAVING, and ON and D_{qo} be the set of rows returned by qₒ. Then, D_{q}⊇D_{qo}⊇R_{c}; R_{c}=Rₚ₁∩. . . ∩Rₚ_{ₙ}. If only predicate mutations in qₒ are considered, then D_{q′}\D_{q}≠∅⇒R_{c′}\R_{c}≠∅. In other words, R_{c′}\R_{c}≠∅ is a condition for D_{q′}\D_{q}≠∅. If only mutating one predicate pᵢ;i∈[1,n] is considered, then R_{c′}\R_{c}≠∅⇒R_{p′}_{ᵢ}⇒Rₚ_{ᵢ}≠∅. Therefore, for any predicate p in a conditional clause of an outermost query, mutating p to achieve R_{p′}\Rₚ≠∅ can result in achieving the global objective, D_{q′}\D_{q}≠∅. For any predicate p in a conditional clause of an outermost query, R_{p′}\Rₚ≠∅ (i.e., satisfying a new row) is defined as the row objective for the predicate mutations to achieve the global objective, D_{q′}\D_{q}≠∅.

Predicates in nested subqueries may be handled differently than predicates in outermost queries and may be based on the parent predicate. When the row objective for the parent predicate is R_{p′}\Rₚ≠∅, let p be a predicate in a nested subquery, let qₙ, pₐ be the parent predicate of p, and r denote a row in the parent query. The row objective R_{p′}\Rₚ≠∅ for predicate pₐ means ∃r; pₐ(r)=FALSE and p has to be mutated to obtain p′ such that p′ₐ(r)=TRUE.

For the subquery type EXISTS, let qₙ be of type EXISTS and rₙ∈D_{q}_{ₙ}, then pₐ(r)=FALSE⇒∀rₙpₐ(r)=FALSE. Let q′ₙ be the mutated subquery of qₙ containing p′ and r′ₙ∈D_{q′}_{ₙ}, then p′ₐ(r)=TRUE⇒∃r′ₙ;p′ₐ(r)=TRUE⇒D_{q′}_{ₙ}\D_{q}_{ₙ}≠∅⇒R_{p′}\Rₚ≠∅. Given that the row objective of the parent predicate is Rₚ′\Rₚ≠∅, the row objective of a predicate in a nested subquery type EXISTS is R_{p′}\Rₚ≠∅. In other words, the row objective of the nested subquery predicate is the same as the row objective of the parent predicate when the parent predicate row objective is R_{p′}\Rₚ≠∅ and the nested subquery type is EXISTS.

For the subquery type FOR_ALL, let qₙ be of type FOR_ALL and rₙ∈D_{q}_{ₙ}, then pₐ(r)=FALSE⇒∃rₙpₐ(r)=FALSE. Let q′ₙ be the mutated subquery of qₙ containing p′ and r′ₙ∈D_{\acute{q}}_{ₙ}, then p′(r)=TRUE⇒∀r′ₙp′ₐ(r)=TRUE⇒D_{q}_{ₙ}\D_{q′}_{ₙ}≠∅⇒Rₚ\R_{p′}≠∅. Given the row objective of the parent predicate is R_{p′}\Rₚ≠∅, the row objective of a predicate in a nested subquery type FOR_ALL is Rₚ\R_{p′}≠∅ (i.e., Rₚ includes at least one row that is not included in R_{p′}). In other words, the row objective of the nested subquery predicate is different than the row objective of the parent predicate when the parent predicate row objective is R_{p′}\Rₚ≠∅ and the nested subquery type is FOR_ALL.

When the row objective of the parent predicate is Rₚ\R_{p′}≠∅, let p be a predicate in a nested subquery, let qₙ, pₐ be the parent predicate of p, and r denotes a row in the parent query. RSO Rₚ\R_{p′}≠∅ for predicate pₐ means ∃rₙ;pₐ(r)=TRUE and p has to be mutated to obtain p′ such that p′ₐ(r)=FALSE.

For the subquery type EXISTS, let qₙ be of type EXISTS and rₙ∈E_{q}_{ₙ}, then pₐ(r)=TRUE⇒∃rₙ;pₐ(r)=TRUE. Let q′ₙ be the mutated subquery of qₙ containing p′ and r′ₙ∈D_{\acute{q}}_{ₙ}, then p′ₐ(r)=FALSE⇒∀r′ₙp′ₐ(r)FALSE⇒D_{q}_{ₙ}\D_{q′}_{ₙ}≠∅⇒Rₚ\R_{p′}≠∅. Given that the row objective of the parent predicate is Rₚ\R_{p′}≠∅, the row objective of a predicate in a nested subquery type EXISTS is Rₚ\R_{p′}≠∅. In other words, the row objective of the nested subquery predicate is the same as the row objective of the parent predicate when the parent predicate row objective is Rₚ\R_{p′}≠∅ and the nested subquery type is EXISTS.

For the subquery type FOR_ALL, let qₙ be of type FOR_ALL and rₙ∈E_{q}_{ₙ}, then pₐ(r)=TRUE⇒∀rₙpₐ(r)=TRUE. Let q′ₙ be the mutated subquery of qₙ containing p′ and r′ₙ∈D_{\acute{q}}_{ₙ}, then p′ₐ(r)=FALSE⇒∀r′ₙ;p′ₐ(r)=FALSE⇒D_{q′}_{ₙ}\D_{q}_{ₙ}≠∅⇒R_{p′}\Rₚ≠∅. Given that the row objective of the parent predicate is Rₚ\R_{p′}≠∅, the RSO of a predicate in a nested subquery type FOR_ALL is R_{p′}\Rₚ≠∅. In other words, the row objective of the nested subquery predicate is different than the row objective of the parent predicate when the parent predicate row objective is Rₚ\R_{p′}≠∅, and the nested subquery type is FOR_ALL.

The component (350) may generate predicate mutations. Two row satisfaction objectives may be identified with the component (320), i) satisfying a new row (R_{p′}\Rₚ≠∅) and ii) satisfying any row but all the rows (Rₚ\R_{p′}≠∅). For each of the row objectives, a mutation condition is formulated using predicate logic for the predicate mutations to use with the constraint solver component to generate mutated predicates that may achieve the respective row objective. The table (450) of FIG. 4 lists mutation conditions that may be mapped to each row objective.

Turning to FIG. 4, the table (400) and the table (450) consolidate information that may be used by the system to generate mutated queries. The mutated queries are generated from mutated predicates that satisfy the mutation conditions identified in the table (450) and satisfy the row objectives of the tables (400) and (450).

The table (400) may be used to map a row objective to a predicate based on a context. The context identifies whether the predicate to be mutated is part of an outermost query or part of a nested subquery, whether the row objective of the parent predicate is a first row objective (e.g., R_{p′}\Rₚ≠∅) or a second row objective (e.g., Rₚ\R_{p′}≠∅), and whether the nested subquery type is EXISTS or FOR_ALL.

The element (402) of the table (400) indicates that when the predicate being considered (i.e., the current predicate) is a predicate in an outermost query, then the row objective for the current predicate is a first row objective (e.g., R_{p′}\Rₚ≠∅). The element (415) of the table (400) indicates that when the current predicate is a predicate of a nested subquery, the row objective for the parent predicate of the predicate to mutate is a first row objective (e.g., R_{p′}\Rₚ≠∅), and the nested subquery type is EXISTS, then the row objective for the current predicate is also the first row objective (e.g., R_{p′}\Rₚ≠∅, i.e., the objective is for the mutated predicate to identify a row that is not identified with the nonmutated predicate). The element (418) of the table (400) indicates that when the current predicate is a predicate of a nested subquery, the row objective for the parent predicate of the predicate to mutate is a first row objective (e.g., R_{p′}\Rₚ≠∅), and the nested subquery type is FOR_ALL, then the row objective for the current predicate is the second row objective (e.g., Rₚ\R_{p′}≠∅, i.e., the objective is for the nonmutated predicate to identify to a row that is not identified with the mutated predicate).

The element (425) of the table (400) indicates that when the current predicate is a predicate of a nested subquery, the row objective for the parent predicate of the predicate to mutate is the second row objective (e.g., Rₚ\R_{p′}≠∅), and the nested subquery type is EXISTS, then the row objective for the current predicate is also the second row objective (e.g., Rₚ\R_{p′}≠∅, i.e., the objective is for the nonmutated predicate to identify a row that is not identified with the mutated predicate). The element (418) of the table (400) indicates that when the current predicate is a predicate of a nested subquery, the row objective for the parent predicate of the predicate to mutate is the second row objective (e.g., Rₚ\R_{p′}≠∅), and the nested subquery type is FOR_ALL, then the row objective for the current predicate is the first row objective (e.g., R_{p′}\Rₚ≠∅, i.e., the objective is for the mutated predicate to identify a row that is not identified with the nonmutated predicate).

The table (450) may be used to map between mutation conditions and row objectives. The element (465) indicates that the first row objective (e.g., R_{p′}\Rₚ≠∅) may be mapped to the first mutation condition (e.g., p′Λ¬p). The first mutation condition has that the mutated predicate (p′) and (Λ) the negation (¬) of the nonmutated (original) predicate (p) evaluates to true. For example, if the nonmutated predicate is “b≤10” and the mutated predicate is “b≤30”, then the mutation condition is satisfied because values of b exist in which “b≤30” (p′) and “b>10” (¬p) (e.g., the integer values 11 through 30) satisfy the mutation condition.

The element (468) indicates that the second row objective (e.g., Rₚ\R_{p′}≠∅) may be mapped to the second mutation condition (e.g., ¬p′Λp). The second mutation condition has that the negation (¬) of the mutated predicate (p′) and (Λ) the nonmutated (original) predicate (p) evaluates to true. For example, if the nonmutated predicate is “e>15” and the mutated predicate is “e≥25”, then the mutation condition is satisfied because values of e exist in which “e≤25” (¬p′) and “e>15” (p) (e.g., the integer values 16 through 25) satisfy the mutation condition.

Turning to FIG. 5, the query mutation algorithm (500) (referred to as the algorithm (500)) generates a potential data exfiltration query (i.e., a mutated query) by applying appropriate mutations to a predicate in a permitted non-exfiltrating query (i.e., a benign query). The algorithm (500) approximates protected rows (as being rows similar to or near rows returned by a benign query) and uses row objectives to generate mutated queries. At a high level, the algorithm (500) mutates permitted non-exfiltrating queries to achieve the global objective, i.e., disclosing new rows. The algorithm (500) mutates a predicate in a given query after determining the row satisfaction objective of the predicate. As a part of the query mutation algorithm (500), a syntax tree (also referred to as an abstract syntax tree (AST)) of the query may be built with annotations indicating the row objectives of predicate nodes in the syntax tree, which is described with the algorithm (550).

The query mutation algorithm (500) starts with parsing the input query to obtain the syntax tree, denoted by T (line 2 of the algorithm (500)). Then, the ANNOTATEWITHRSO procedure (illustrated in the algorithm (550)) is called to annotate the predicate nodes in the syntax tree (T) with respective row objectives (line 3 of the algorithm (500)).

The algorithm (550) visits each node in the input syntax tree in a depth-first manner as illustrated in the VISIT procedure from lines 5 to 12 of the algorithm (550). While visiting the nodes, the algorithm (550) annotates the nodes of type ‘predicate’ with their respective row objectives (line 7 of the algorithm (550)). The row objective of a predicate is solved by the SoLvERSO procedure (lines 13 to 22 of the algorithm (550)). The SoLvERSO procedure strictly follows the row objectives derivations listed in the table (400). In particular, it takes two inputs, s—the type of nested subquery the predicate is in and r—the row objective of the parent predicate. Based on these two inputs, the row objective of the given predicate node is derived.

Once the annotated syntax tree (Tₐ) is obtained, the algorithm (500) selects a predicate node p from Tₐ to mutate (line 4 of the algorithm (500)). The selection may be done by collecting the predicate nodes in the annotated syntax tree by traversing the tree and randomly selecting a node from the collection. The selected predicate node is then mutated (line 5 of the algorithm (500)) in accordance with the row objective from annotated in the predicate node. The mutation may be done by using predicate mutations with a solver. The algorithm (500) generates the mutated query string using the mutated syntax tree (line 6 of the algorithm (500)).

Turning to FIG. 6, the tables X (600) and Y (650) may be used to implement and test targeted query mutation for disclosing protected rows in a database. Let X and Y be the tables (600) and (650) in a database instance, respectively. The table X (600) includes the protected row (608), which may be highlighted red. The data in the table X (600) may be accessed based on the data in the table Y (650) Turning to FIG. 7, the query q₁ (700) is a permitted non-exfiltrating query (which may also be referred to as a benign query). The query q₁ (700) discloses the row (602) of table X (600) of FIG. 6, which may be highlighted green. The predicate p (705) in the query q₁ (700) is in an outermost query of the query q₁ (700). The query mutation technique generates a data exfiltration query, i.e., the mutated query q′₁ (750) from the query q₁ (700).

The query q₁ (700) is parsed (line 2 of the algorithm (500) of FIG. 5) to obtain the syntax tree (720). The syntax tree prior to being annotated may be identified as T.

The syntax tree (720) is annotated (line 3 of the algorithm (500) of FIG. 5) to include the annotation (730) with a row objective to generate an annotated version of the syntax tree (720). The annotated version of the syntax tree (720) may be referred to as Tₐ.

The predicate node (725) is selected (line 4 of the algorithm (500) of FIG. 5). The predicate p (705) has a value of p=b≤10 AND c≥55.

The predicate p (705) is mutated (line 5 of the algorithm (500) of FIG. 5) in accordance with the row objective R_{p′}\Rₚ≠∅. To execute the mutation, the mutation condition for the row objective is identified from the table (450) of FIG. 4 and applied to the predicate p (705) so that p′Λ¬p=pΛ(b>10 OR c<55). The predicate p (705) is mutated to obtain the mutated predicate p′ (755) with a value of p′=b≤30 AND c≥55 in which the constant 10 from the predicate p (705) is mapped to 30 (i.e., 10→30), which satisfies the mutation condition that p′∇¬p. The mutated predicate p′ (755) is one of many possible mutated predicates.

The mutated query q′₁ (750) is generated (line 6 of the algorithm (500) of FIG. 5) and includes the mutated predicate p′ (755). The mutated query q′₁ (750) is generated as q′₁=SELECT*FROM X WHERE B≤30 AND c≥55 from the modified version of the syntax tree Tₐ (720).

The table (780) shows the output from the mutated query q′₁ (750). The table (780) includes the protected row (788) that corresponds to the protected row (608) of the table X (600) of FIG. 6.

Turning to FIG. 8, the query q₂ (800) is a permitted non-exfiltrating query (which may also be referred to as a benign query). The query q₂ (800), like the query q₁ (700) of FIG. 7, discloses the row (602) of table X (600) of FIG. 6, which may be highlighted green. The query q₂ (800) includes the predicate p (805) represented by the predicate node (825), which is part of a nested subquery to which the parent predicate (807) is represented by the parent predicate node (835) with the parent row objective annotation (830). The query mutation technique generates a data exfiltration query, i.e., the mutated query q′₂ (850) from the query q₂ (800).

The query q₂ (800) is parsed (line 2 of the algorithm (500) of FIG. 5) to obtain the syntax tree (820). The syntax tree prior to being annotated may be identified as T.

The syntax tree (820) is annotated (line 3 of the algorithm (500) of FIG. 5) to include the annotations (830) and (835) (each with a row objective) to generate an annotated version of the syntax tree (820). The annotated version of the syntax tree (820) may be referred to as Tₐ.

The predicate node (825) is selected (line 4 of the algorithm (500) of FIG. 5). The predicate p=e>15 from the query q₂ (800).

The predicate p (805) is mutated (line 5 of the algorithm (500) of FIG. 5) in accordance with the row objective Rₚ\R_{p′}≠∅. To execute the mutation, the mutation condition for the row objective is identified from the table (450) of FIG. 4 and applied to the predicate p (805) so that ¬p′Λp=¬p′Λ(e>15). The predicate p (805) is mutated to obtain the mutated predicate p′ (855) with a value of p′=e>25 in which the constant 15 is mapped to 25 (i.e., 15→25), which satisfies the mutation condition that ¬p′Λp. The mutated predicate p′ (855) is one of many possible mutated predicates.

The mutated query q′₂ (850) is generated (line 6 of the algorithm (500) of FIG. 5) and includes the mutated predicate p′ (855). The mutated query q′₂ (850) is generated as q′₂=SELECT*FROM X WHERE b≤10 OR c>ALL (SELECT d FROM Y WHERE e>25) from the modified version of the syntax tree Tₐ (820).

The table (880) shows the output from the mutated query q′₁ (850). The table (880) includes the protected row (888) that corresponds to the protected row (608) of the table X (600) of FIG. 6.

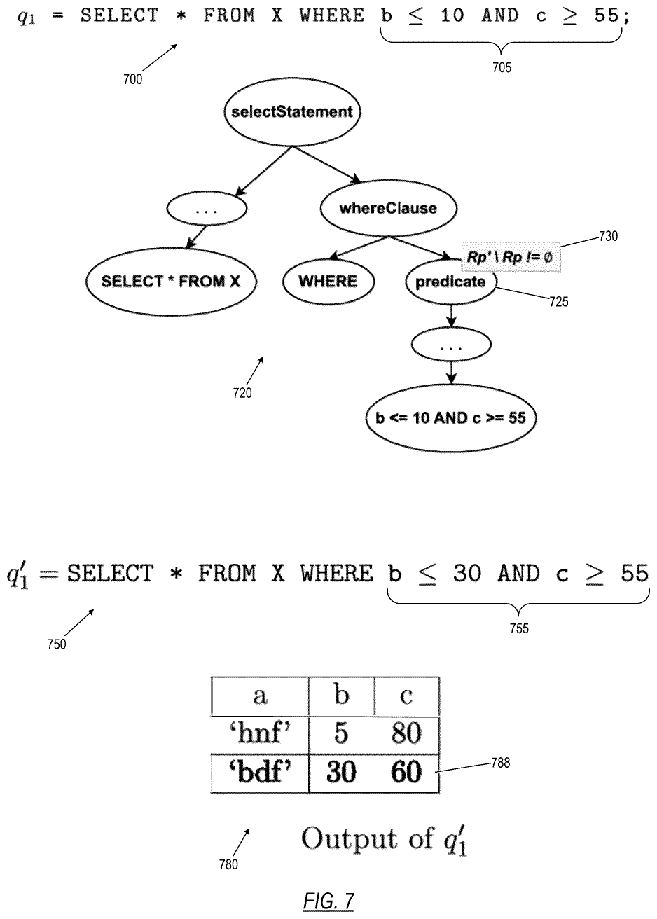

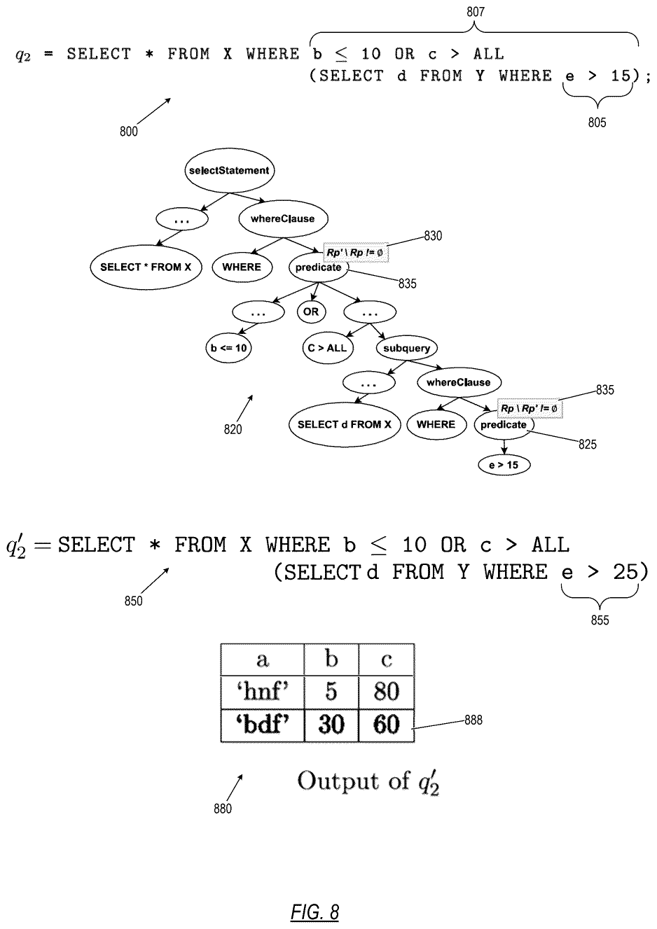

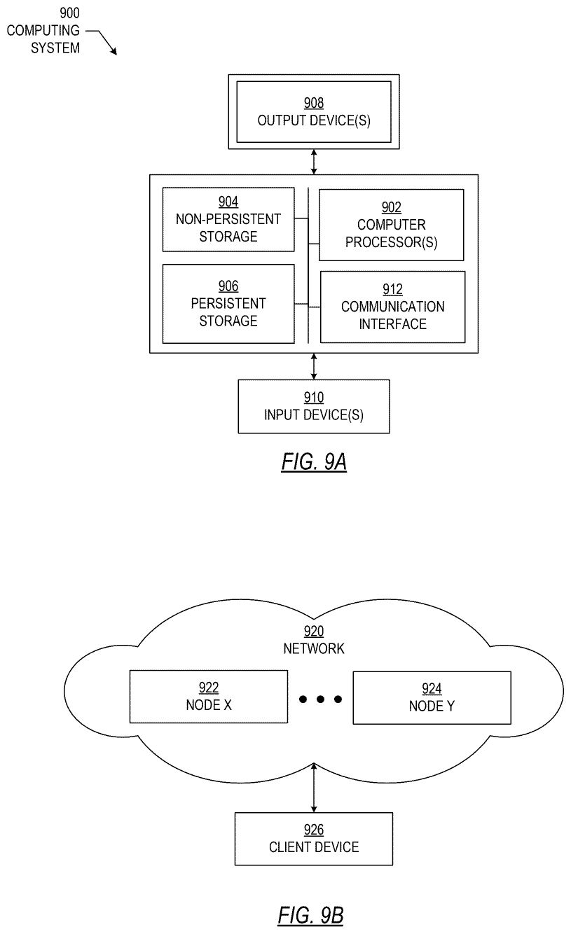

Embodiments may be implemented on a special purpose computing system specifically designed to achieve the improved technological result. Turning to FIG. 9A and FIG. 9B, the special purpose computing system (900) may include one or more computer processors (902), non-persistent storage (904), persistent storage (906), a communication interface (912) (e.g., Bluetooth interface, infrared interface, network interface, optical interface, etc.), and numerous other elements and functionalities that implement the features and elements of the disclosure. The computer processor(s) (902) may be an integrated circuit for processing instructions. The computer processor(s) (902) may be one or more cores or micro-cores of a processor. The computer processor(s) (902) includes one or more processors. The one or more processors may include a central processing unit (CPU), a graphics processing unit (GPU), a tensor processing unit (TPU), combinations thereof, etc.

The input device(s) (910) may include a touchscreen, keyboard, mouse, microphone, touchpad, electronic pen, or any other type of input device. The input device(s) (910) may receive inputs from a user that are responsive to data and messages presented by the output device(s) (908). The inputs may include text input, audio input, video input, etc., which may be processed and transmitted by the computing system (900) in accordance with the disclosure. The communication interface (912) may include an integrated circuit for connecting the computing system (900) to a network (not shown) (e.g., a local area network (LAN), a wide area network (WAN) such as the Internet, mobile network, or any other type of network), and/or to another device, such as another computing device.

Further, the output device(s) (908) may include a display device, a printer, external storage, or any other output device. One or more of the output device(s) (908) may be the same or different from the input device(s) (910). The input device(s) (910) and the output device(s) (908) may be locally or remotely connected to the computer processor(s) (902). Many different types of computing systems exist, and the aforementioned input device(s) (910) and output device(s) (908) may take other forms. The output device(s) (908) may display data and messages that are transmitted and received by the computing system (900). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (900) in FIG. 9A may be connected to or be a part of a network. For example, as shown in FIG. 9B, the network (920) may include multiple nodes (e.g., node X (922) and node Y (924)). Each node may correspond to a computing system, such as the computing system (900) shown in FIG. 9A, or a group of nodes combined may correspond to the computing system (900) shown in FIG. 9A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (900) may be located at a remote location and connected to the other elements over a network.

The nodes (e.g., node X (922) and node Y (924)) in the network (920) may be configured to provide services for a client device (926), including receiving requests and transmitting responses to the client device (926). For example, the nodes may be part of a cloud computing system. The client device (926) may be a computing system, such as the computing system (900) shown in FIG. 9A. Further, the client device (926) may include and/or perform all or a portion of one or more embodiments of the disclosure.

The computing system (900) of FIG. 9A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or a semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an “or” may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above may be devised which do not depart from the scope of the claims as disclosed herein. Accordingly, the scope should be limited only by the attached claims.

1. A method comprising:
selecting a predicate from a benign query, the benign query being to a database comprising a protected row, wherein the benign query does not access the protected row;
identifying a row satisfaction objective for the predicate using a context of the predicate within the benign query and using a mutation condition;
mutating the predicate to generate a mutated predicate, wherein mutating the predicate is targeted by modifying the predicate to satisfy the mutation condition and the row satisfaction objective;
mutating the benign query that does not access the protected row to generate a mutated query that accesses the protected row by replacing the predicate of the benign query with the mutated predicate; and
rejecting a subsequent query using the mutated query.

2. The method of claim 1, further comprising:
receiving the benign query.

3. The method of claim 1, wherein identifying the row satisfaction objective comprises parsing the benign query to generate a syntax tree representing the benign query.

4. The method of claim 1, wherein identifying the row satisfaction objective comprises traversing a syntax tree of the benign query to identify the predicate.

5. The method of claim 1, wherein identifying the row satisfaction objective comprises determining the context using a syntax tree to identify a parent objective and a nested subquery type for the predicate.

6. The method of claim 1, wherein identifying the row satisfaction objective comprises resolving the row satisfaction objective using a parent objective and a nested subquery type.

7. The method of claim 1, wherein identifying the row satisfaction objective comprises annotating a syntax tree to include the row satisfaction objective with a predicate node representing the predicate within the syntax tree.

8. The method of claim 1, wherein mutating the predicate comprises adjusting an element within the predicate using a temperature.

9. The method of claim 1, further comprising:
returning the mutated query as a negative sample executed by the injection prevention application.

10. The method of claim 1, further comprising:
executing the injection prevention application to reject the subsequent query using the mutated query as a negative sample.

11. A system comprising:
at least one computer processor; and
an application that, when executing on the at least one computer processor, performs operations comprising:
selecting a predicate from a benign query, the benign query being to a database comprising a protected row, wherein the benign query does not access the protected row,
identifying a row satisfaction objective for the predicate using a context of the predicate within the benign query and using a mutation condition,
mutating the predicate to generate a mutated predicate, wherein mutating the predicate is targeted by modifying the predicate to satisfy the mutation condition and the row satisfaction objective,
mutating the benign query that does not access the protected row to generate a mutated query that accesses the protected row by replacing the predicate of the benign query with the mutated predicate, and
rejecting a subsequent query using the mutated query.

12. The system of claim 11, wherein the application performs operations further comprising:
receiving the benign query.

13. The system of claim 11, wherein identifying the row satisfaction objective comprises parsing the benign query to generate a syntax tree representing the benign query.

14. The system of claim 11, wherein identifying the row satisfaction objective comprises traversing a syntax tree of the benign query to identify the predicate.

15. The system of claim 11, wherein identifying the row satisfaction objective comprises determining the context using a syntax tree to identify a parent objective and a nested subquery type for the predicate.

16. The system of claim 11, wherein identifying the row satisfaction objective comprises resolving the row satisfaction objective using a parent objective and a nested subquery type.

17. The system of claim 11, wherein identifying the row satisfaction objective comprises annotating a syntax tree to include the row satisfaction objective with a predicate node representing the predicate within the syntax tree.

18. The system of claim 11, wherein mutating the predicate comprises adjusting an element within the predicate using a temperature.

19. The system of claim 11, wherein the application performs operations further comprising:
returning the mutated query as a negative sample executed by the injection prevention application.

20. A non-transitory computer readable medium comprising instructions executable by at least one processor to perform:
selecting a predicate from a benign query, the benign query being to a database comprising a protected row, wherein the benign query does not access the protected row;
identifying a row satisfaction objective for the predicate using a context of the predicate within the benign query and using a mutation condition;
mutating the predicate to generate a mutated predicate, wherein mutating the predicate is targeted by modifying the predicate to satisfy the mutation condition and the row satisfaction objective;
mutating the benign query that does not access the protected row to generate a mutated query that accesses the protected row by replacing the predicate of the benign query with the mutated predicate; and
rejecting a subsequent query using the mutated query.
